(19) United States
(12) Patent Application Publication
(10) Pub. No.: US 2026/0336311 A1
(43) Pub. Date: Oct. 29, 2026

(54) CONVEYANCE APPARATUS AND PROCESSING APPARATUS

(71) Applicant: SEIKO EPSON CORPORATION, Tokyo (JP)

(72) Inventors: Riku MAEDA, SHIOJIRI-SHI (JP); Hideo TAKI, SHIOJIRI-SHI (JP); Yuki HARA, SHIOJIRI-SHI (JP); Hiroyuki MAEDA, MATSUMOTO-SHI (JP)

(21) Appl. No.: 19/658,835

(22) Filed: Apr. 27, 2026

(30) Foreign Application Priority Data
Apr. 28, 2025 (JP) 2025-074645

(51) Int. Cl. B41J 11/00; B41J 13/10; B41J 29/393

(52) U.S. Cl. CPC B41J 11/0095; B41J 13/103; B41J 29/393

(57) ABSTRACT

A conveyance apparatus includes a conveyor configured to convey a medium; a first conveyance path along which the medium is conveyed by the conveyor; a second conveyance path along which the medium is conveyed by the conveyor; a first detector configured to detect multi-feed of the medium conveyed along the first conveyance path; a second detector configured to detect multi-feed of the medium conveyed along the second conveyance path; and a controller, wherein the controller includes a control circuit configured to control a selected one of the first detector and the second detector, and a switch coupled to the control circuit and configured to switch a control target of the control circuit between the first detector and the second detector.

The present application is based on, and claims priority from JP Application Serial Number 2025-074645, filed Apr. 28, 2025, the disclosure of which is hereby incorporated by reference herein in its entirety.

### BACKGROUND

### 1. Technical Field

The present disclosure relates to a conveyance apparatus and a processing apparatus.

### 2. RELATED ART

JP-A-2014-84188 describes a conveyance apparatus including multiple supply paths along which a medium is supplied and multiple detectors that are respectively located in the multiple supply paths and detect multi-feed of the medium.

JP-A-2014-84188 is an example of the related art.

A control circuit that controls the detectors is typically required to allow the detectors to detect the multi-feed. When the control circuit is provided for each of the detectors, the size of the conveyance apparatus tends to increase.

### SUMMARY

A conveyance apparatus according to an aspect of the present disclosure includes a conveyor configured to convey a medium; a first conveyance path along which the medium is conveyed by the conveyor; a second conveyance path along which the medium is conveyed by the conveyor; a first detector configured to detect multi-feed of the medium conveyed along the first conveyance path; a second detector configured to detect multi-feed of the medium conveyed along the second conveyance path; and a controller, wherein the controller includes a control circuit configured to selectively control the first detector and the second detector, and a switch coupled to the control circuit and configured to switch a control target of the control circuit between the first detector and the second detector.

A processing apparatus according to another aspect of the present disclosure includes the conveyance apparatus described above; and a processing unit configured to perform processing on the medium conveyed along the first conveyance path and the second conveyance path.

### BRIEF DESCRIPTION OF THE DRAWINGS

FIG. 1 is a diagrammatic view showing an example of a processing apparatus including a conveyance apparatus.

FIG. 2 is a diagrammatic view showing an electrical configuration of the conveyance apparatus.

FIG. 3 is a graph showing the relationship between a voltage applied to a detector and an output value from the detector.

### DESCRIPTION OF EMBODIMENTS

An example of a processing apparatus including a conveyance apparatus will be described below with reference to the drawings. The processing apparatus is an inkjet printer that records characters or an image such as a photograph by ejecting ink, which is an example of a liquid, onto a medium such as a paper sheet, a fabric sheet, or a film.

### Processing apparatus

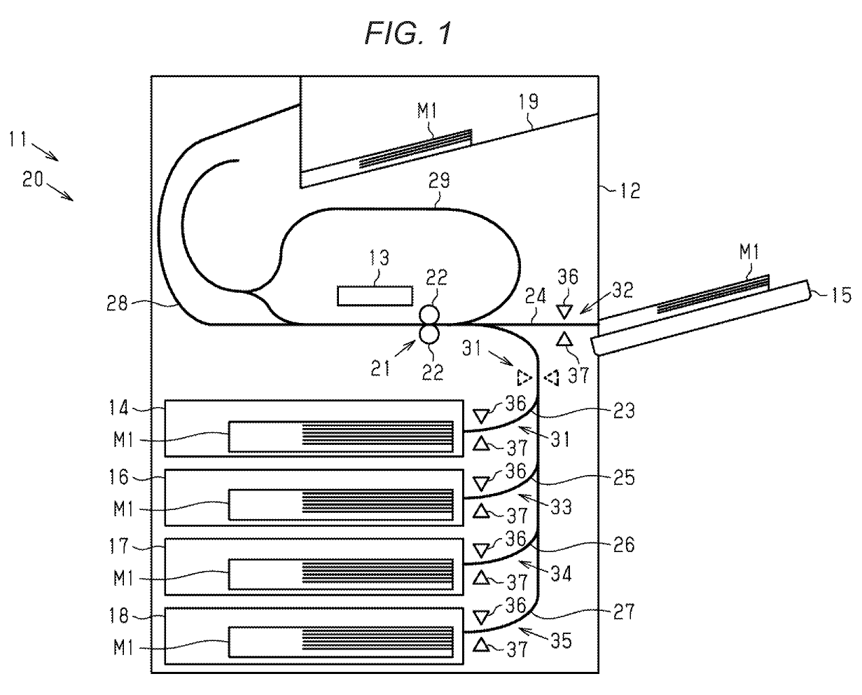

A processing apparatus 11 includes an enclosure 12, as shown in FIG. 1. The enclosure 12 houses various elements provided in the processing apparatus 11.

The processing apparatus 11 includes a processing unit 13. The processing unit 13 is configured to perform processing on a medium M1. In an example, the processing unit 13 is a recorder that records an image on the medium M1. The recorder records an image on the medium M1 by ejecting a liquid onto the medium M1. In an example, the processing apparatus 11 is therefore a recording apparatus.

The processing unit 13 may be a reader that reads the medium M1. In this case, the processing apparatus 11 is a reading apparatus, an example of which is a scanner. The processing unit 13 may staple the medium M1, fold the medium M1, or stack multiple media M1 into a bundle. The processing apparatus 11 may, for example, be a collator.

The processing apparatus 11 includes multiple stackers. In an example, the processing apparatus 11 includes a first stacker 14, a second stacker 15, a third stacker 16, a fourth stacker 17, and a fifth stacker 18. The stackers are each configured to stack the medium M1. The stackers may each be a cassette loaded into the enclosure 12. The stackers may each be a tray attached to the enclosure 12.

The multiple stackers may be configured with multiple cassettes. The multiple stackers may be configured with multiple trays. The multiple stackers may be configured with one or more cassettes and one or more trays. In an example, the multiple stackers are configured with multiple cassettes and one tray. In detail, the first stacker 14 is a cassette. The second stacker 15 is a tray. The third stacker 16, the fourth stacker 17, and the fifth stacker 18 are each a cassette. The multiple stackers may be configured, for example, with a first cassette, a second cassette, a third cassette, a fourth cassette, and a tray. The example described above is not necessarily employed, and the first stacker 14, the second stacker 15, the third stacker 16, and the fourth stacker 17 may each be a cassette, and the fifth stacker 18 may be a tray. Still alternatively, the multiple stackers may be configured with one cassette and multiple trays, multiple cassettes and multiple trays, or one cassette and one tray. Any one of the multiple cassettes provided in a conveyance apparatus 20 may be the first stacker 14. Any one of the multiple trays provided in the conveyance apparatus 20 may be the first stacker 14. Any one of the one or more cassettes and the one or more trays provided in the conveyance apparatus 20 may be the first stacker 14. The first stacker 14, the second stacker 15, the third stacker 16, the fourth stacker 17, and the fifth stacker 18 are each configured with either a cassette or a tray.

The cassettes are located below the processing unit 13. The multiple cassettes are vertically arranged in the processing apparatus 11. In an example, the first stacker 14, the third stacker 16, the fourth stacker 17, and the fifth stacker 18 are therefore arranged in this order downward. The tray is located alongside the processing unit 13. In an example, the second stacker 15 is therefore located alongside the processing unit 13. The configuration described above is not necessarily employed, and the first stacker 14, the second stacker 15, the third stacker 16, and the fourth stacker 17 may be arranged in this order downward, and the fifth stacker 18 may be located alongside the processing unit 13.

The processing apparatus 11 may include a discharge tray 19. The discharge tray 19 receives the medium M1 having been processed by the processing unit 13. The discharge tray 19 is attached to the enclosure 12. In an example, the discharge tray 19 is located above the processing unit 13.

The processing apparatus 11 includes the conveyance apparatus 20. The conveyance apparatus 20 is configured to convey the medium M1. The conveyance apparatus 20 conveys the medium M1 stacked at any of the stackers. The conveyance apparatus 20 conveys the medium M1 from any of the stackers toward the processing unit 13. The processing unit 13 performs processing on the medium M1 conveyed by the conveyance apparatus 20. In an example, the conveyance apparatus 20 is housed in the enclosure 12. The conveyance apparatus 20 is incorporated in the enclosure 12.

### Conveyance apparatus

The conveyance apparatus 20 will next be described.

The conveyance apparatus 20 includes a conveyor 21. The conveyor 21 is configured to convey the medium M1. The conveyor 21 includes one or more rollers 22. The conveyor 21 conveys the medium M1 from any of the stackers with the aid of the rollers 22. The conveyor 21 conveys the medium M1 from any of the cassettes or conveys the medium M1 from any of the trays with the aid of the rollers 22.

The conveyance apparatus 20 includes multiple conveyance paths. The number of the conveyance paths provided in the conveyance apparatus 20 is equal to the number of the stackers. In an example, the conveyance apparatus 20 includes five conveyance paths. In detail, the conveyance apparatus 20 includes a first conveyance path 23, a second conveyance path 24, a third conveyance path 25, a fourth conveyance path 26, and a fifth conveyance path 27. The conveyance paths are each a path along which the medium M1 is conveyed. The conveyance paths are each a path along which the medium M1 is conveyed by the conveyor 21. The conveyance paths extend in the enclosure 12.

The conveyance paths extend from the stackers toward the processing unit 13. The first conveyance path 23 extends from the first stacker 14. The second conveyance path 24 extends from the second stacker 15. The third conveyance path 25 extends from the third stacker 16. The fourth conveyance path 26 extends from the fourth stacker 17. The fifth conveyance path 27 extends from the fifth stacker 18. In an example, the first conveyance path 23, the third conveyance path 25, the fourth conveyance path 26, and the fifth conveyance path 27 extend from the respective cassettes. For example, the first conveyance path 23 extends from the first cassette, the third conveyance path 25 extends from the second cassette, the fourth conveyance path 26 extends from the third cassette, and the fifth conveyance path 27 extends from the fourth cassette. The second conveyance path 24 extends from the tray. The configuration described above is not necessarily employed, and the first conveyance path 23, the second conveyance path 24, the third conveyance path 25, and the fourth conveyance path 26 may extend from the respective cassettes, and the fifth conveyance path 27 may extend from the tray. Still alternatively, the multiple conveyance paths may extend from one cassette and multiple trays, from multiple cassettes and multiple trays, or from one cassette and one tray. For example, one of the first conveyance path 23 and the second conveyance path 24 may be a path extending from any of the cassettes toward the processing unit 13. The other of the first conveyance path 23 and the second conveyance path 24 may be a path extending from the tray toward the processing unit 13. One of the first conveyance path 23 and the second conveyance path 24 may be a path extending from the first cassette toward the processing unit 13. The other of the first conveyance path 23 and the second conveyance path 24 may be a path extending from the second cassette toward the processing unit 13.

The multiple conveyance paths may extend so as to merge with each other. The multiple conveyance paths may merge with each other in the course of extending from the stackers toward the processing unit 13. The multiple conveyance paths extending from the multiple cassettes may merge with each other. The medium M1 may be conveyed from each of the first cassette and the second cassette to the processing unit 13 along the conveyance path extending from the first cassette. The conveyance path extending from each of the cassettes and the conveyance path extending from the tray may merge with each other. The medium M1 may be conveyed from each of the cassettes and the tray to the processing unit 13 along the conveyance path extending from the cassette. The medium M1 may be conveyed from each of the cassettes and the tray to the processing unit 13 along the conveyance path extending from the tray. The multiple conveyance paths may separately extend toward the processing unit 13.

The conveyance apparatus 20 includes a discharge path 28. The discharge path 28 is a path along which the medium M1 is discharged. The discharge path 28 is a path along which the medium M1 having been processed by the processing unit 13 is discharged. The discharge path 28 extends from the processing unit 13 toward the discharge tray 19. The discharge path 28 extends from the conveyance paths toward the discharge tray 19.

The conveyance apparatus 20 may include a reversal path 29. The reversal path 29 is a path used when images are recorded on opposite surfaces of the medium M1. The reversal path 29 is a path along which the processed medium M1 is conveyed to the processing unit 13 again. The reversal path 29 extends so as to reverse the orientation of the medium M1 and return the medium M1 to the processing unit 13. The reversal path 29 extends so as to branch off the discharge path 28. The reversal path 29 extends from the discharge path 28 so as to merge with the conveyance path where the conveyance paths merge with one another. In detail, the reversal path 29 extends so as to merge with a portion of a merged conveyance path where the conveyance paths merge with one another. The reversal path 29 reverses the orientation of the medium M1 upside down in the course of returning the medium M1 from the discharge path 28 to the merged conveyance paths. In an example, the reversal path 29 extends so as to make a detour between the processing unit 13 and the discharge tray 19.

The conveyance apparatus 20 includes multiple detectors. In an example, the conveyance apparatus 20 includes a first detector 31, a second detector 32, a third detector 33, a fourth detector 34, and a fifth detector 35. The detectors are configured to detect multi-feed of the medium M1. The multi-feed means that multiple media M1 are conveyed with the multiple media M1 overlapping with each other. In the conveyance apparatus 20, multiple media M1 may be conveyed from some of the stackers with the multiple media M1 overlapping with each other. The detectors are each an ultrasonic sensor. The detectors detect multi-feed of the medium M1 by measuring the intensity of the ultrasonic wave attenuated by the medium M1. When multi-feed of the medium M1 occurs, the ultrasonic wave has a higher attenuation ratio. Each of the detectors is not limited to an ultrasonic sensor, and may be an optical sensor, a capacitance sensor, or a mechanical sensor.

The detectors each include a transmission sensor 36 and a reception sensor 37. The first detector 31, the second detector 32, the third detector 33, the fourth detector 34, and the fifth detector 35 each include the transmission sensor 36 and the reception sensor 37. The transmission sensor 36 is configured to transmit an ultrasonic wave. The transmission sensor 36 transmits an ultrasonic wave having an intensity according to an applied voltage. The reception sensor 37 is located so as to face the transmission sensor 36. The reception sensor 37 is configured to receive the ultrasonic wave transmitted from the transmission sensor 36. The reception sensor 37 outputs an output value according to the intensity of the received ultrasonic wave.

The detectors are located so as to detect multi-feed of the medium M1 conveyed along any of the conveyance paths. The detectors are each so located that the transmission sensor 36 and the reception sensor 37 sandwich the corresponding conveyance path. The detectors are each located so as to detect multi-feed of the medium M1 at a portion of the corresponding conveyance path where the conveyance path and another conveyance path do not merge with each other. The first detector 31 is located so as to detect multi-feed of the medium M1 conveyed along the first conveyance path 23. The second detector 32 is located so as to detect multi-feed of the medium M1 conveyed along the second conveyance path 24. The third detector 33 is located so as to detect multi-feed of the medium M1 conveyed along the third conveyance path 25. The fourth detector 34 is located so as to detect multi-feed of the medium M1 conveyed along the fourth conveyance path 26. The fifth detector 35 is located so as to detect multi-feed of the medium M1 conveyed along the fifth conveyance path 27. In an example, the first detector 31, the third detector 33, the fourth detector 34, and the fifth detector 35 detect multi-feed of the medium M1 conveyed from the respective cassettes. The second detector 32 detects multi-feed of the medium M1 conveyed from the tray. The configuration described above is not necessarily employed, and the first detector 31, the second detector 32, the third detector 33, and the fourth detector 34 may detect multi-feed of the medium M1 conveyed from the respective cassettes. The fifth detector 35 may detect multi-feed of the medium M1 conveyed from the tray. Still alternatively, the multiple detectors may detect multi-feed of the medium M1 conveyed from one cassette and multiple trays, multi-feed of the medium M1 conveyed from multiple cassettes and multiple trays, or multi-feed of the medium M1 conveyed from one cassette and one tray. For example, one of the first detector 31 and the second detector 32 may be located so as to detect multi-feed of the medium M1 in a path extending from any of the cassettes toward the processing unit 13. The other one of the first detector 31 and the second detector 32 may be located so as to detect multi-feed of the medium M1 in a path extending from the tray toward the processing unit 13. One of the first detector 31 and the second detector 32 may be located so as to detect multi-feed of the medium M1 in the path extending from the first cassette toward the processing unit 13. The other of the first detector 31 and the second detector 32 may be located so as to detect multi-feed of the medium M1 in the path extending from the second cassette toward the processing unit 13.

The detectors may be located so as to detect multi-feed of the medium M1 conveyed from any of the multiple stackers. Any of the detectors may be located so as to detect multi-feed of the medium M1 at a portion of the corresponding conveyance path where the conveyance path and another conveyance path merge with each other. For example, the first detector 31 may be located so as to detect multi-feed of the medium M1 at a portion where the first conveyance path 23, the third conveyance path 25, the fourth conveyance path 26, and the fifth conveyance path 27 merge with one another, as indicated by a broken line in FIG. 1. In this case, the first detector 31 may detect multi-feed of the medium M1 conveyed from any of the first stacker 14, the third stacker 16, the fourth stacker 17, and the fifth stacker 18. The first detector 31 may detect multi-feed of the medium M1 conveyed from any of the first cassette, the second cassette, the third cassette, and the fourth cassette.

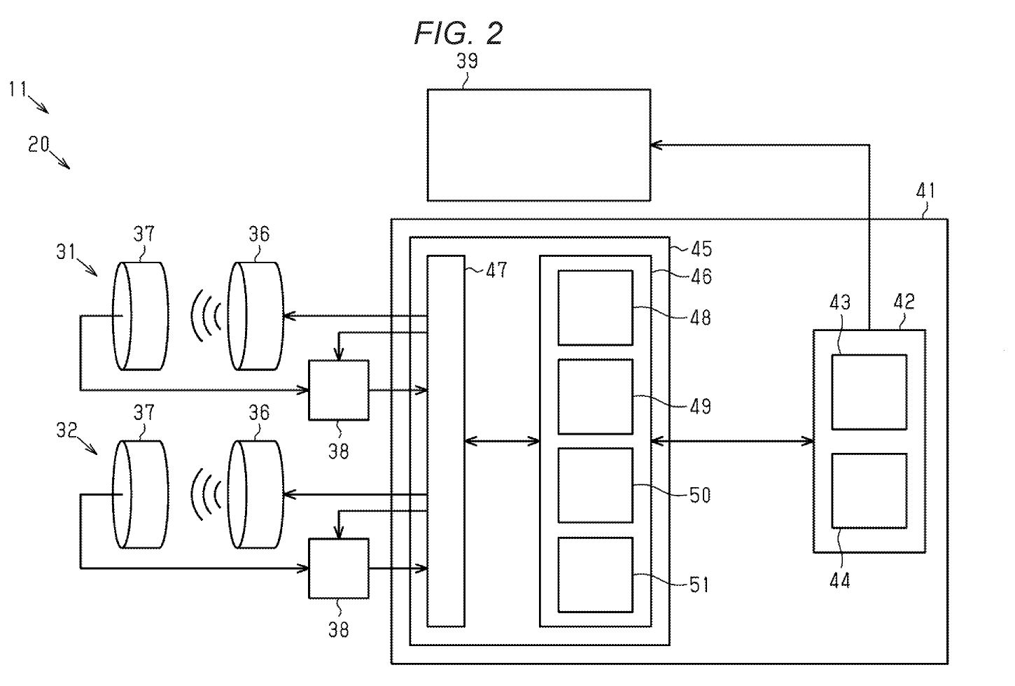

The detectors include comparison circuits 38, as shown in FIG. 2. In an example, the multiple detectors each include the comparison circuit 38. The detectors may include a comparison circuit 38 common to the multiple detectors. The comparison circuits 38 are each coupled to the corresponding reception sensor 37. The comparison circuits 38 are each a circuit that compares an output value from the reception sensor 37 with a threshold. The comparison circuits 38 each output a signal indicating the result of the comparison between the output value and the threshold. The comparison circuits 38 each include, for example, a comparator that compares the output value with the threshold. In addition to the comparator, the comparison circuits 38 may each include an amplifier that amplifies the output value from the reception sensor 37, a sample-and-hold circuit that holds the output value amplified by the amplifier, and other elements. The comparison circuits 38 may each output the output value held by the sample-and-hold circuit in addition to the result of the comparison.

The comparison circuits 38 are each configured to detect occurrence of the multi-feed by comparing the output value with the threshold. In detail, the comparison circuits 38 each detect occurrence of the multi-feed by comparing the output value with a multi-feed threshold. For example, the comparison circuits 38 each output a high-level signal when the output value falls below the multi-feed threshold. The comparison circuits 38 each output a low-level signal when the output value is greater than or equal to the multi-feed threshold.

The multi-feed threshold is a predetermined value. In detail, the multi-feed threshold is a value specified based on the output value in a state where no medium M1 is present. In an example, the multi-feed threshold is specified based on the output value in a state in which no medium M1 is located between any of the transmission sensors 36 and the corresponding reception sensor 37 at the time of shipment. The multi-feed threshold is specified, for example, so as to be 50% of the output value in the state in which no medium M1 is present at the time of shipment.

The comparison circuits 38 each do not necessarily compare the output value with the multi-feed threshold and may compare the output value with a calibration threshold. The calibration threshold is a threshold used when the detectors are calibrated. The comparison circuits 38 may each compare the output value with the calibration threshold at the time of the calibration. The calibration threshold indicates a predetermined range. The calibration threshold has, for example, an upper limit and a lower limit. The comparison circuits 38 may each output signals of different levels for the cases where the output value falls within the range, where the output value exceeds the range, and where the output value falls below the range.

The conveyance apparatus 20 includes a power supply circuit 39. The power supply circuit 39 is a circuit that supplies power to various elements provided in the conveyance apparatus 20. The power supply circuit 39 supplies power to the multiple detectors. The power supply circuit 39 may supply power not only to the conveyance apparatus 20 but also to other elements provided in the processing apparatus 11. The power supply circuit 39 may supply power, for example, to the processing unit 13.

The conveyance apparatus 20 includes a controller 41. The controller 41 is configured to control various elements provided in the conveyance apparatus 20. The controller 41 is configured to control the detectors. The controller 41 is configured to control the power supply circuit 39. The controller 41 may control the conveyor 21 in addition to the detectors and the power supply circuit 39. The controller 41 may control not only the conveyance apparatus 20 but also the elements provided in the processing apparatus 11. For example, the controller 41 may control the processing unit 13.

The controller 41 is configured to accept a conveyance instruction. The conveyance instruction is an instruction to convey the medium M1. The conveyance instruction is transmitted to the controller 41 when a user operates the conveyance apparatus 20 or the user operates an external terminal coupled to the conveyance apparatus 20. The conveyance instruction may be contained in a processing instruction. The processing instruction is an instruction to perform processing on the medium M1. In an example, the processing instruction is a recording instruction. The recording instruction is an instruction to record an image on the medium M1. The conveyance instruction may be contained in a job transmitted to the controller 41. The conveyance instruction contains an instruction to specify a stacker serving as a supply source, an instruction to specify the number of media M1 to be conveyed from the stacker, and other instructions. The conveyance instruction may contain an instruction to convey the medium M1 from each of multiple stackers. The conveyance instruction may contain an instruction to specify the order in accordance with which the media M1 from the multiple stackers are conveyed. The conveyance instruction may contain, for example, an instruction to convey the medium M1 from the first stacker 14, and an instruction to convey the medium M1 from the second stacker 15 after the medium M1 is conveyed from the first stacker 14.

The controller 41 includes a primary control circuit 42. The primary control circuit 42 is a circuit that controls the detectors and the power supply circuit 39. The primary control circuit 42 includes a processor 43 and a memory 44. The processor 43 may include a CPU, an MPU, an ASIC, an FPGA, or the like. The memory 44 includes a ROM, a RAM, and the like. The memory 44 may store thresholds such as the multi-feed threshold and the calibration threshold. The processor 43 is configured to carry out processes in accordance with a program stored in the memory 44. The processor 43 controls the conveyance apparatus 20 by executing the program.

The controller 41 includes one or more control mechanisms 45. The control mechanism 45 is configured to control the detectors. In detail, the control mechanism 45 is configured to control multiple ones of the detectors. The control mechanism 45 is configured to control, for example, the first detector 31 and the second detector 32. The control mechanism 45 may be configured to control three or more detectors. The control mechanism 45 may be configured to control all the detectors. The control mechanism 45 is coupled to multiple ones of the detectors. The control mechanism 45 is coupled to multiple ones of the transmission sensors 36 and multiple ones of the reception sensors 37. The control mechanism 45 is coupled to the primary control circuit 42. The control mechanism 45 is configured to control the detectors in accordance with an instruction from the primary control circuit 42.

The control mechanism 45 includes one or more control circuits 46. The control circuit 46 is a circuit that controls the detectors. The control circuit 46 may include a CPU, an MPU, an ASIC, an FPGA, or the like. The control circuit 46 may be a dedicated circuit that controls the detectors, or a general-purpose circuit that controls not only the detectors but also other elements.

The control circuit 46 is a circuit that selectively controls the multiple detectors. In an example, the control circuit 46 selectively controls the first detector 31 and the second detector 32. That is, the control circuit 46 is configured to select between the first detector 31 and the second detector 32. The control circuit 46 may selectively control three or more detectors. The control circuit 46 may selectively control all the detectors.

The control mechanism 45 may include multiple control circuits 46. The control mechanism 45 may include, for example, a control circuit 46 that selectively controls the first detector 31 and the second detector 32, and a control circuit 46 that selectively controls the third detector 33, the fourth detector 34, and the fifth detector 35.

The control mechanism 45 includes a switch 47. The switch 47 is coupled to multiple ones of the detectors. In an example, the switch 47 is coupled to the first detector 31 and the second detector 32. The switch 47 is coupled to the transmission sensor 36 of each of the detectors coupled to the switch 47. The switch 47 is coupled to the comparison circuit 38 of each of the detectors coupled to the switch 47.

The switch 47 is configured to switch the control target of the control circuit 46. In an example, the switch 47 is configured to switch the control target of the control circuit 46 between the first detector 31 and the second detector 32. The switch 47 switches the destination to which a control signal transmitted from the control circuit 46 is transmitted between the first detector 31 and the second detector 32.

When the first detector 31 is used, the controller 41 causes the switch 47 to switch the control target of the control circuit 46 to the first detector 31. When the second detector 32 is used, the controller 41 causes the switch 47 to switch the control target of the control circuit 46 to the second detector 32. The control circuit 46 thus selectively controls multiple detectors via the switch 47. Since the control circuit 46 controls multiple detectors, the number of the control circuits 46 is reduced as compared with a case where the controller 41 includes the control circuit 46 for each of the detectors. The reduction in the number of the control circuits 46 suppresses an increase in the size of the conveyance apparatus 20. The reduction in the number of the control circuits 46 further leads to reduction in the cost of the conveyance apparatus 20.

Since the control circuit 46 selectively controls multiple detectors, the multiple detectors cannot be controlled in parallel. In an example, while controlling one of the first detector 31 and the second detector 32, the control circuit 46 cannot control the other. Therefore, when multiple detectors are used, and, for example, when the medium M1 is conveyed along each of multiple conveyance paths, it is preferable to efficiently control the multiple detectors.

The control circuit 46 includes a specifying circuit 48. The specifying circuit 48 is a circuit that specifies the control target of the control circuit 46. The specifying circuit 48 outputs a specifying signal in accordance with an instruction from the primary control circuit 42. The specifying signal is a signal used to specify the control target of the control circuit 46. The specifying circuit 48 transmits the specifying signal to the switch 47. The switch 47 switches the control target based on the specifying signal.

The control circuit 46 includes a transmission circuit 49. The transmission circuit 49 is a circuit that controls the transmission sensors 36. The transmission circuit 49 outputs a transmission signal that causes each of the transmission sensors 36 to transmit the ultrasonic wave. The transmission circuit 49 transmits the transmission signal to the switch 47. The transmission circuit 49 transmits the transmission signal to each detector specified by the specifying signal via the switch 47.

The control circuit 46 includes a notification circuit 50. The notification circuit 50 is a circuit that notifies the result of the comparison between the output value from any of the detectors and the threshold. The notification circuit 50 notifies the primary control circuit 42 of the result of the comparison. The notification circuit 50 receives a signal from any of the detectors. For example, the notification circuit 50 receives the result of the comparison between the output value and the multi-feed threshold from any of the comparison circuits 38 via the switch 47. In an example, the notification circuit 50 notifies the primary control circuit 42 that the multi-feed has occurred when the notification circuit 50 receives a high-level signal. The notification circuit 50 may receive the result of the comparison between the output value and the calibration threshold from any of the comparison circuits 38 via the switch 47. The notification circuit 50 may notify the primary control circuit 42 of the result of the comparison between the output value and the calibration threshold.

The control circuit 46 includes a threshold circuit 51. The threshold circuit 51 is a circuit that outputs a threshold. The threshold circuit 51 outputs a threshold in accordance with an instruction from the primary control circuit 42. The threshold circuit 51 outputs the threshold to any of the comparison circuits 38. The threshold circuit 51 may output the threshold to the primary control circuit 42. The threshold circuit 51 outputs the multi-feed threshold. The threshold circuit 51 may output the calibration threshold in addition to the multi-feed threshold.

The controller 41 needs to calibrate the detectors to maintain the multi-feed detection accuracy. The detectors have individual differences and experience aging, environmental changes, or the like, so that the intensity of the ultrasonic wave transmitted and received by each of the detectors changes. When the intensity of the ultrasonic wave transmitted and received by each of the detectors changes, there is a concern that the detector cannot accurately detect the multi-feed. For example, when the intensity of the ultrasonic wave transmitted and received by each of the detectors decreases, there is a concern that the detector detects that the multi-feed has occurred even though no multi-feed has occurred during the conveyance of the medium M1.

The controller 41 calibrates the detectors by driving the detectors in the state in which no medium M1 is located. In detail, the controller 41 calibrates each of the detectors based on an output value in the state in which no medium M1 is located between the transmission sensor 36 and the reception sensor 37. To calibrate each of the detectors, the controller 41 first measures the output value from the detectors in the state in which no medium M1 is located. The controller 41 then compares the output value in the state in which no medium M1 is located with the calibration threshold. The controller 41 then changes the multi-feed threshold or the applied voltage based on the result of the comparison between the output value and the calibration threshold. When the output value is outside the range indicated by the calibration threshold, the controller 41 changes the multi-feed threshold or the applied voltage. Note that the calibration threshold may indicate a predetermined range or a predetermined value. That is, the calibration threshold may be an upper limit or a lower limit indicating a predetermined range, or may be a predetermined threshold itself.

When the output value is outside the range indicated by the calibration threshold, the controller 41 may change the multi-feed threshold. When the output value exceeds the upper limit, the controller 41 increases the multi-feed threshold. When the output value falls below the lower limit, the controller 41 decreases the multi-feed threshold. When the output value exceeds the upper limit, the intensity of any of the transmitted and received ultrasonic waves is greater than a typical value. In this case, the multi-feed detection accuracy is maintained by increasing the multi-feed threshold. When the output value falls below the lower limit, the intensity of any of the transmitted and received ultrasonic waves is smaller than the typical value. In this case, the multi-feed detection accuracy is maintained by decreasing the multi-feed threshold. The controller 41 changes the multi-feed threshold by controlling the threshold circuit 51 via the primary control circuit 42. When the output value exceeds the upper limit, the controller 41 may change the multi-feed threshold to a first multi-feed threshold greater than the typical value. When the output value falls below the lower limit, the controller 41 may change the multi-feed threshold to a second multi-feed threshold smaller than the typical value. The controller 41 may change the multi-feed threshold by the difference between the output value and the calibration threshold. When the output value exceeds the calibration threshold, the controller 41 may increase the multi-feed threshold by the difference between the output value and the calibration threshold. When the output value falls below the calibration threshold, the controller 41 may decrease the multi-feed threshold by the difference between the calibration threshold and the output value.

When the output value is outside the range indicated by the calibration threshold, the controller 41 may change the applied voltage. The controller 41 adjusts the output value by changing the voltage applied to the detectors. When the applied voltage increases, the intensity of each of the ultrasonic waves transmitted and received by the detectors increases. Therefore, when the applied voltage increases, the output value increases. When the applied voltage decreases, the intensity of each of the ultrasonic waves transmitted and received by the detectors decreases. Therefore, when the applied voltage decreases, the output value decreases. The controller 41 decreases the applied voltage when the output value exceeds the upper limit. The controller 41 increases the applied voltage when the output value falls below the lower limit. The multi-feed detection accuracy is thus maintained. The controller 41 controls the applied voltage by controlling the power supply circuit 39. The controller 41 controls the applied voltage by controlling the power supply circuit 39 via the primary control circuit 42. To calibrate the detectors, changing the applied voltage is likely to require a longer period than changing the multi-feed threshold. This is because it takes time to stabilize the applied voltage. This is also because multiple trials are required in some cases to determine the multi-feed threshold. For example, when the multi-feed threshold is determined from the difference between the calibration threshold and the output value, the output value may be measured only once. When the output value is outside the range indicated by the calibration threshold, to change the multi-feed threshold or the applied voltage in a way that the output value falls within the range indicated by the calibration threshold, it is necessary to repeat trial and adjustment until the output value falls within the range indicated by the calibration threshold. In this case, changing the applied voltage is likely to require a longer period than changing the multi-feed threshold because it takes time to stabilize the applied voltage, so that the period between the trials tends to increase.

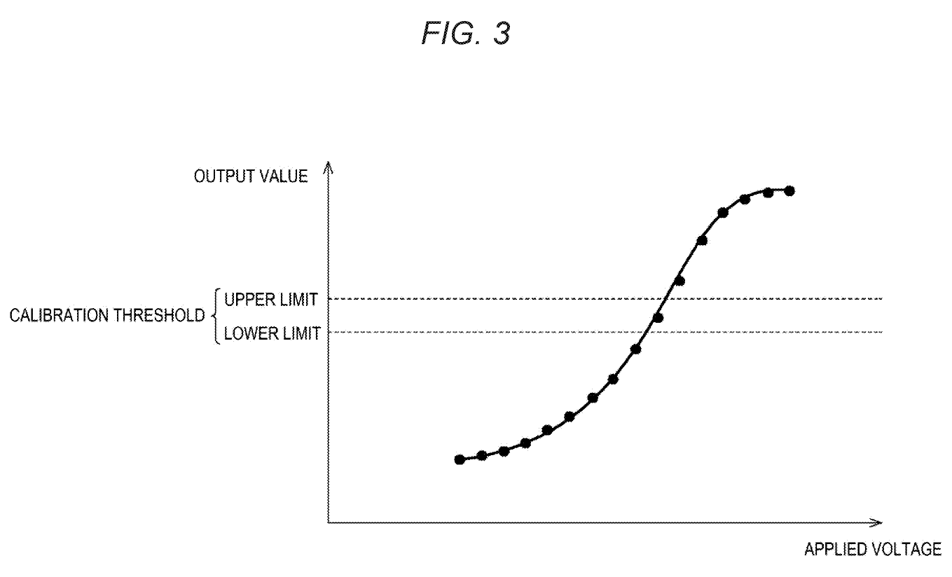

When the output value is outside the range indicated by the calibration threshold, the controller 41 may change the applied voltage in a way that the output value falls within the range indicated by the calibration threshold, as shown in FIG. 3. When the output value exceeds the upper limit, the controller 41 may decrease the applied voltage in a way that the output value is smaller than or equal to the upper limit. When the output value falls below the lower limit, the controller 41 may increase the applied voltage in a way that the output value is greater than or equal to the lower limit. The output value in the state in which no medium M1 is located is thus maintained constant. As a result, the multi-feed detection accuracy is maintained.

The controller 41 may calibrate the detectors by applying a voltage value for calibration to the detectors via the power supply circuit 39. The voltage value for calibration is a predetermined value. The voltage value for calibration is stored, for example, in the memory 44. The voltage value for calibration may be a voltage value that allows the output value to fall within the range indicated by the calibration threshold in a typical environment. The voltage value for calibration may be a voltage value that allows the output value to fall within the range indicated by the calibration threshold in an environment in which the user uses the processing apparatus 11. The voltage value for calibration may be the maximum or the minimum of a voltage applicable to the detectors. When the voltage value for calibration is the maximum or the minimum of the applicable voltage, the direction in which the applied voltage is changed can be restricted to one direction when the applied voltage is so changed that the output value falls within the range indicated by the calibration threshold.

When the voltage value for calibration is the maximum voltage applicable to the detectors, the controller 41 decreases the applied voltage in a way that the output value falls within the range indicated by the calibration threshold. Depending on the configuration of the power supply circuit 39, the period required to increase the voltage may be longer than the period required to decrease the voltage. Therefore, when the applied voltage is adjusted by the power supply circuit 39, the applied voltage can be efficiently changed by applying a relatively large voltage to the detectors at the time of the calibration.

When the voltage value for calibration is the minimum voltage applicable to the detectors, the controller 41 increases the applied voltage in a way that the output value falls within the range indicated by the calibration threshold. Depending on the configuration of the power supply circuit 39, the period required to decrease the voltage may be longer than the period required to increase the voltage. Therefore, when the applied voltage is adjusted by the power supply circuit 39, the applied voltage can be efficiently changed by applying a relatively small voltage to the detectors at the time of the calibration.

### Timing at which calibration is performed

The timing at which the calibration is performed will next be described.

The controller 41 calibrates the detectors at a predetermined timing. The controller 41 calibrates the detectors, for example, at the timing of power-on, at the timing of power-off, at the timing of recovery from a sleep mode, the timing of transition to the sleep mode, the timing when the number of recorded media M1 reaches a predetermined number, the timing when the operation period reaches a predetermined period, the timing when the conveyance instruction is accepted, the timing when the medium M1 is conveyed, or any other timing. The timings when the calibration is performed described above may be combined with each other as appropriate.

The controller 41 calibrates the detectors before any of the detectors detects multi-feed of the medium M1. The controller 41 may start calibrating the detectors before starting conveying the medium M1, or may start calibrating the detectors after starting conveying the medium M1. The controller 41 may start the calibration in a way that the calibration of the detectors is completed before the medium M1 reaches any of the detectors. The controller 41 may start the calibration in a way that the calibration of the detectors is completed after the conveyance of the medium M1 starts but before the medium M1 reaches any of the detectors. Specifically, the controller 41 may start the calibration in a way that the calibration of the first detector 31 is completed after the medium M1 is conveyed from the first stacker 14 along the first conveyance path 23 but before the medium M1 reaches the first detector 31. The controller 41 may start the calibration in a way that the calibration of the second detector 32 is completed after the medium M1 is conveyed from the second stacker 15 along the second conveyance path 24 but before the medium M1 reaches the second detector 32. In this case, since the conveyance of the medium M1 and the calibration are performed in parallel, the efficiency of the conveyance of the medium M1 is improved.

The controller 41 may separately calibrate the multiple detectors. The controller 41 may perform the calibration whenever any of the stackers each serving as the supply source is switched to another. When the control target of the control circuit 46 is switched by the switch 47, the controller 41 may calibrate the detector that is the control target. For example, after the specifying circuit 48 outputs the specifying signal to the switch 47, the controller 41 may calibrate the detector indicated by the specifying signal. When the control target of the control circuit 46 is switched during execution of a job, continuous execution of multiple jobs, or the like, the controller 41 may calibrate the detector to which the control target has been switched.

When the control target of the control circuit 46 is switched by the switch 47 to the first detector 31, the controller 41 may calibrate the first detector 31. The controller 41 switches the control target of the control circuit 46 to the first detector 31 via the switch 47 before the first detector 31 detects multi-feed of the medium M1. At this point in time, the controller 41 may calibrate the first detector 31. When the control target of the control circuit 46 is switched by the switch 47 to the second detector 32, the controller 41 may calibrate the second detector 32. The controller 41 switches the control target of the control circuit 46 to the second detector 32 via the switch 47 before the second detector 32 detects multi-feed of the medium M1. At this point in time, the controller 41 may calibrate the second detector 32. As described above, since the detectors are each calibrated immediately before the detector is used, the multi-feed detection accuracy is likely to be maintained.

To separately calibrate the multiple detectors, whenever the medium M1 is conveyed along any of the conveyance paths, the controller 41 may calibrate the detector located in the conveyance path. That is, whenever the medium M1 passes through any of the detectors, the controller 41 may calibrate the detector. It is preferable in this case that the controller 41 may calibrate the detector by changing the multi-feed threshold. When any of the detectors is calibrated whenever the medium M1 is conveyed along the corresponding conveyance path, the multi-feed detection accuracy is improved, but there is a concern that the conveyance efficiency of the medium M1 decreases. As described above, the calibration performed by changing the multi-feed threshold requires a shorter period than the calibration performed by changing the applied voltage. Performing the calibration by changing the multi-feed threshold whenever the medium M1 is conveyed along any of the conveyance paths is therefore likely to maintain the multi-feed detection accuracy while reducing the decrease in the conveyance efficiency.

The controller 41 may measure the output value from the first detector 31 in the state in which no medium M1 is located at the first detector 31 whenever the medium M1 is conveyed along the first conveyance path 23. For example, whenever the medium M1 passes through the first detector 31, the controller 41 may measure the output value from the first detector 31 in the state in which no medium M1 is located at the first detector 31. The controller 41 may change the multi-feed threshold based on the result of the comparison between the measured output value and the calibration threshold whenever the medium M1 is conveyed along the first conveyance path 23. The multi-feed detection accuracy is thus likely to be maintained while the decrease in the conveyance efficiency is reduced.

The controller 41 may measure the output value from the second detector 32 in the state in which no medium M1 is located at the second detector 32 whenever the medium M1 is conveyed along the second conveyance path 24. For example, whenever the medium M1 passes through the second detector 32, the controller 41 may measure the output value from the second detector 32 in the state in which no medium M1 is located at the second detector 32. The controller 41 may change the multi-feed threshold based on the result of the comparison between the measured output value and the calibration threshold whenever the medium M1 is conveyed along the second conveyance path 24. The multi-feed detection accuracy is thus likely to be maintained while the decrease in the conveyance efficiency is reduced.

The controller 41 may collectively calibrate multiple ones of the detectors. The controller 41 may calibrate one detector and may also calibrate another detector along therewith. When the control target of the control circuit 46 is switched by the switch 47, the controller 41 may calibrate a detector that is the control target of the control circuit 46 and may calibrate another detector along therewith. For example, after calibrating the detector indicated by the specifying signal output by the specifying circuit 48, the controller 41 may switch the control target to another detector via the switch 47 and calibrate the other detector. The calibration is thus efficiently performed on the multiple detectors. The controller 41 may collectively calibrate the multiple detectors at the start of a job, at the time of power-on, at the time of power-off, at the time of recovery from the sleep mode, at the time of transition to the sleep mode, or the time of any other operation. The controller 41 may collectively calibrate the multiple detectors when the number of processed media M1 reaches a predetermined number, when the operation period reaches a predetermined period, or any other criterion is satisfied.

When the medium M1 is conveyed along any of the conveyance paths, the controller 41 may calibrate the detector that detects multi-feed of the medium M1 along the conveyance path and calibrate another detector. The first detector 31 and the second detector 32 are thus efficiently calibrated.

The controller 41 may calibrate the first detector 31 and the second detector 32 when the medium M1 is conveyed along the first conveyance path 23. The controller 41 may calibrate the first detector 31 and the second detector 32 before the first detector 31 detects multi-feed of the medium M1. The controller 41 may calibrate the first detector 31 and the second detector 32 when executing a job of conveying the medium M1 from the first stacker 14. That is, the controller 41 may calibrate the first detector 31 and calibrate the second detector 32 along therewith. The controller 41 may calibrate the first detector 31 and the second detector 32 when executing a job of conveying the medium M1 from the second stacker 15. That is, the controller 41 may calibrate the second detector 32 and calibrate the first detector 31 along therewith. Calibrating multiple detectors at the start of a job eliminates the need to perform the calibration at the timing when the stacker serving as the supply source is switched to another, the timing between jobs, or any other timing. The conveyance efficiency of the medium M1 is thus improved.

The controller 41 may calibrate the second detector 32 and then calibrate the first detector 31 when the medium M1 is conveyed along the first conveyance path 23. The controller 41 may calibrate the second detector 32 and then calibrate the first detector 31 before the first detector 31 detects multi-feed of the medium M1. The controller 41 may, for example, calibrate the second detector 32 and then calibrate the first detector 31 when executing a job of conveying the medium M1 from the first stacker 14. To detect multi-feed of the medium M1 via the first detector 31, when the first detector 31 is calibrated and then the second detector 32 is calibrated, it is necessary to change the control target of the control circuit 46 back to the first detector 31. The conveyance efficiency of the medium M1 is therefore improved by calibrating the second detector 32 and then calibrating the first detector 31. The controller 41 may calibrate the first detector 31 and then calibrate the second detector 32 when the medium M1 is conveyed along the second conveyance path 24.

When the medium M1 is conveyed along any of the conveyance paths, the controller 41 may start calibrating multiple ones of the detectors before starting conveying the medium M1, or may start calibrating multiple ones of the detectors after starting conveying the medium M1. The controller 41 may start the calibration in a way that before the medium M1 reaches any of the detectors, calibrating the detector and another detector is completed. The controller 41 may, for example, start the calibration in a way that after the conveyance of the medium M1 starts but before the medium M1 reaches any of the detectors, calibrating the detector and another detector is completed. The controller 41 may start the calibration in a way that after the medium M1 is conveyed from the first stacker 14 along the first conveyance path 23 but before the medium M1 reaches the first detector 31, calibrating the first detector 31 and the second detector 32 is completed. The controller 41 may start the calibration in a way that after the medium M1 is conveyed from the second stacker 15 along the second conveyance path 24 but before the medium M1 reaches the second detector 32, calibrating the first detector 31 and the second detector 32 is completed. In this case, since the conveyance of the medium M1 and the calibration are performed in parallel, the efficiency of the conveyance of the medium M1 is improved.

The controller 41 may apply the result of the calibration of any of the detectors to the calibration of another detector. For example, the controller 41 may apply the multi-feed threshold changed in accordance with the result of the calibration of any of the detectors to another detector. For example, the controller 41 may apply the applied voltage changed in accordance with the result of the calibration of any of the detectors to another detector. In this case, it is not necessary to measure on a detector basis the output value in the state in which no medium M1 is located. The multiple detectors are thus efficiently calibrated. The controller 41 does not necessarily directly apply the result of the calibration of any of the detectors to the calibration of another detector, and may apply the result of the calibration of the detector converted in accordance with the other detector. The timing when the controller 41 applies the result of the calibration of any of the detectors to the calibration of another detector may be the timing when the detector is calibrated or the timing when the control target is switched from the detector to the other detector.

The controller 41 may apply the result of the calibration of the first detector 31 to the calibration of the second detector 32. When the control target of the control circuit 46 is switched by the switch 47 to the first detector 31, the controller 41 measures the output value from the first detector 31 in the state in which no medium M1 is located at the first detector 31. The controller 41 calibrates the first detector 31 based on the result of the comparison between the output value and the threshold. When the first detector 31 is calibrated and then the control target of the control circuit 46 is switched by the switch 47 to the second detector 32, the controller 41 may calibrate the second detector 32 based on the result of the comparison in the first detector 31. The controller 41 may thus apply the result of the calibration of the first detector 31 to the calibration of the second detector 32.

The controller 41 may apply the result of the calibration of the second detector 32 to the calibration of the first detector 31. When the control target of the control circuit 46 is switched to the second detector 32 by the switch 47, the controller 41 measures the output value from the second detector 32 in the state in which no medium M1 is located at the second detector 32. The controller 41 calibrates the second detector 32 based on the result of the comparison between the output value and the threshold. When the second detector 32 is calibrated and then the control target of the control circuit 46 is switched to the first detector 31 by the switch 47, the controller 41 may calibrate the first detector 31 based on the result of the comparison in the second detector 32. The controller 41 may thus apply the result of the calibration of the second detector 32 to the calibration of the first detector 31.

After collectively calibrating the multiple detectors, the controller 41 may not perform the calibration until a fixed period elapses. For example, after calibrating the multiple detectors, the controller 41 may not perform the calibration until the conveyance apparatus 20 transitions to a standby state. When the controller 41 calibrates, before the medium M1 reaches any of the detectors, the detector and another detector, and the control target of the control circuit 46 is switched from the detector to the other detector, the controller 41 may not calibrate the other detector. When the controller 41 calibrates multiple ones of the detectors at the start of a job, the controller 41 may not calibrate the detectors when the control target of the control circuit 46 is switched, for example, during the execution of job or during continuous execution of multiple jobs. A concern that the calibration is repeated in a short period is thus suppressed. The conveyance efficiency of the medium M1 is therefore improved.

After collectively calibrating the first detector 31 and the second detector 32 when the medium M1 is conveyed along the first conveyance path 23, the controller 41 may not calibrate the second detector 32 until a fixed period elapses. The controller 41 calibrates the first detector 31 and the second detector 32 when the medium M1 is conveyed along the first conveyance path 23. After the controller 41 calibrates the first detector 31 and the second detector 32, and then the switch 47 switches the control target of the control circuit 46 from the first detector 31 to the second detector 32, the controller 41 may not calibrate the second detector 32. The controller 41 calibrates the first detector 31 and the second detector 32 when receiving the conveyance instruction to convey the medium M1 from the first stacker 14. The controller 41 may not calibrate the second detector 32 when the control target of the control circuit 46 is switched from the first detector 31 to the second detector 32 while the conveyance apparatus 20 operates in accordance with the conveyance instruction. A concern that the second detector 32 is repeatedly calibrated in a short period is thus reduced.

After collectively calibrating the first detector 31 and the second detector 32 when the medium M1 is conveyed along the second conveyance path 24, the controller 41 may not calibrate the first detector 31 until the fixed period elapses. The controller 41 calibrates the first detector 31 and the second detector 32 when the medium M1 is conveyed along the second conveyance path 24. After the controller 41 calibrates the first detector 31 and the second detector 32, and then the switch 47 switches the control target of the control circuit 46 from the second detector 32 to the first detector 31, the controller 41 may not calibrate the first detector 31. The controller 41 calibrates the first detector 31 and the second detector 32 when receiving the conveyance instruction to convey the medium M1 from the second stacker 15. The controller 41 may not calibrate the first detector 31 when the control target of the control circuit 46 is switched from the second detector 32 to the first detector 31 while the conveyance apparatus 20 operates in accordance with the conveyance instruction. A concern that the first detector 31 is repeatedly calibrated in a short period is thus reduced.

The controller 41 may combine the timings described above when the calibration is performed with each other as appropriate in accordance with the arrangement of the detectors. For example, when the first detector 31 is located so as to detect multi-feed of the media M1 conveyed from multiple ones of the stackers, the controller 41 may calibrate the first detector 31 and the second detector 32 as appropriate.

The controller 41 may separately calibrate the first detector 31 and the second detector 32. The controller 41 may calibrate the first detector 31 when the medium M1 is conveyed along the first conveyance path 23, the third conveyance path 25, the fourth conveyance path 26, and the fifth conveyance path 27. The controller 41 may calibrate the second detector 32 when the medium M1 is conveyed along the second conveyance path 24.

The controller 41 may collectively calibrate the first detector 31 and the second detector 32. The controller 41 may collectively calibrate the first detector 31 and the second detector 32 when the medium M1 is conveyed along the first conveyance path 23. The controller 41 may calibrate the first detector 31 and the second detector 32 when the medium M1 is conveyed along the first conveyance path 23. The controller 41 may collectively calibrate the first detector 31 and the second detector 32 when the medium M1 is conveyed along the second conveyance path 24. The controller 41 may calibrate the first detector 31 and the second detector 32 when the medium M1 is conveyed along the second conveyance path 24.

In general, the switching frequency at which supplying the medium M1 from any of the cassettes to supplying the medium M1 from the tray is lower than the switching frequency at which supplying the medium M1 from the tray to supplying the medium M1 from any of the cassettes. Therefore, when the medium M1 is conveyed from the tray along the second conveyance path 24, the calibration may be collectively performed assuming that there is a possibility of switching from the tray to any of the cassettes. When the medium M1 is conveyed from any of the cassettes along the first conveyance path 23, the third conveyance path 25, the fourth conveyance path 26, and the fifth conveyance path 27, the calibration may be separately performed assuming that the possibility of the switching is low.

### Effects and advantages of embodiment

Effects and advantages of the embodiment described above will next be described.
(1) The controller 41 includes the control circuit 46, which selectively controls the first detector 31 and the second detector 32. The controller 41 includes the switch 47, which is coupled to the control circuit 46 and switches the control target of the control circuit 46 between the first detector 31 and the second detector 32. According to the configuration described above, the controller 41 can control the first detector 31 and the second detector 32 via the common control circuit 46. A concern that the size of the entire apparatus increases is thus suppressed.
(2) When the control target of the control circuit 46 is switched by the switch 47 to the first detector 31, the controller 41 calibrates the first detector 31. The controller 41 calibrates the second detector 32 when the control target of the control circuit 46 is switched by the switch 47 to the second detector 32. According to the configuration described above, the multi-feed detection accuracy is improved by the calibration. Furthermore, as compared with a case where the first detector 31 and the second detector 32 are collectively calibrated, downtime that occurs when only the first detector 31 is used can be suppressed.
(3) When the control target of the control circuit 46 is switched by the switch 47 to the first detector 31, the controller 41 measures the output value from the first detector 31 in the state in which no medium M1 is located at the first detector 31. The controller 41 calibrates the first detector 31 based on the result of the comparison between the measured output value and the calibration threshold. When the first detector 31 is calibrated and then the control target of the control circuit 46 is switched by the switch 47 to the second detector 32, the controller 41 calibrates the second detector 32 based on the result of the comparison in the first detector 31. To calibrate any of the detectors, the controller 41 requires an output value from the detector in the state in which no medium M1 is located. Therefore, when calibrating the first detector 31, the controller 41 measures the output value from the first detector 31 in the state in which no medium M1 is located at the first detector 31. When the first detector 31 is calibrated, and then the switch 47 switches the control target of the control circuit 46 to the second detector 32, calibrating the second detector 32 as in the case of the first detector 31 may lower the conveyance efficiency. According to the configuration described above, when the first detector 31 is calibrated and then the control target of the control circuit 46 is switched by the switch 47 to the second detector 32, the controller 41 calibrates the second detector 32 based on the result of the comparison between the output value from the first detector 31 and the calibration threshold. That is, the controller 41 calibrates the second detector 32 without measuring the output value from the second detector 32 in the state in which no medium M1 is located at the second detector 32. In short, the controller 41 uses the result of the comparison in the first detector 31 for the calibration of the second detector 32. A concern that the conveyance efficiency decreases is thus reduced.
(4) The controller 41 calibrates the first detector 31 and the second detector 32 when the medium M1 is conveyed along the first conveyance path 23. According to the configuration described above, the first detector 31 and the second detector 32 are efficiently calibrated. In particular, when both the first detector 31 and the second detector 32 are used, and, for example, when the conveyance source is switched from the first stacker 14 to the second stacker 15, a situation in which the conveyance is stopped halfway can be suppressed.
(5) The controller 41 calibrates the second detector 32 and then calibrates the first detector 31. When the first detector 31 is calibrated, and then the second detector 32 is calibrated, it is necessary to switch the control target of the control circuit 46 by the switch 47 to the first detector 31 again in order to detect multi-feed of the medium M1 conveyed along the first conveyance path 23. According to the configuration described above, since the second detector 32 is calibrated and then the first detector 31 is calibrated, the first detector 31 can detect multi-feed of the medium M1 conveyed along the first conveyance path 23 without switching the control target of the control circuit 46 by the switch 47 after the calibration of the first detector 31 is completed.
(6) The controller 41 calibrates the first detector 31 and the second detector 32 when the medium M1 is conveyed along the first conveyance path 23. After the controller 41 calibrates the first detector 31 and the second detector 32, and then the switch 47 switches the control target of the control circuit 46 from the first detector 31 to the second detector 32, the controller 41 does not calibrate the second detector 32. According to the configuration described above, a concern that the second detector 32 is repeatedly calibrated in a short period is reduced. A concern that the processing efficiency decreases is thus reduced.
(7) The controller 41 measures the output value from the first detector 31 in the state in which no medium M1 is located at the first detector 31 whenever the medium M1 is conveyed along the first conveyance path 23. The controller 41 may calibrate the first detector 31 by changing the multi-feed threshold based on the result of the comparison between the output value and the calibration threshold. According to the configuration described above, since the period required to change the multi-feed threshold is relatively short, the processing efficiency is unlikely to decrease even when the calibration is performed whenever the medium M1 is conveyed. Performing the calibration whenever the medium M1 is conveyed improves the multi-feed detection accuracy.
(8) The controller 41 measures the output value in the state in which no medium M1 is located at the first detector 31. The controller 41 calibrates the first detector 31 by increasing the applied voltage in a way that the output value falls within the range indicated by the calibration threshold based on the result of the comparison between the output value and the calibration threshold. When the applied voltage increases, the output value increases. Depending on the configuration of the power supply circuit 39, the period required to decrease the applied voltage may be longer than the period required to increase the applied voltage. Therefore, according to the configuration described above, when the output value in the state in which no medium M1 is located at the first detector 31 is smaller than the calibration threshold, the controller 41 increases the applied voltage to efficiently adjust the output value.
(9) In the configuration in which the first conveyance path 23 extends from any of the cassettes toward the processing unit 13 and the second conveyance path 24 extends from the tray toward the processing unit 13, an advantage provided by sharing the single control circuit 46 is readily provided. This is because, in general, supplying a medium from any of the cassettes and supplying a medium from the tray are not often continuously switched from one to the other. That is, the reason for the above is a low frequency at which the control target of the control circuit 46 is switched between the first detector 31 and the second detector 32.
(10) In the configuration in which the medium M1 is conveyed from each of the first cassette and the second cassette to the processing unit 13 along the first conveyance path 23, multi-feed of the medium M1 conveyed from the first cassette and multi-feed of the medium M1 conveyed from the second cassette are detected by the first detector 31. The number of the detectors is therefore reduced as compared with the configuration in which a detector is provided on a cassette basis. In general, the frequency of continuous switching between supplying a medium from the first cassette and supplying a medium from the second cassette is higher than the frequency of continuous switching between supplying a medium from any of the cassettes and supplying a medium from the tray. The detectors are therefore more efficiently calibrated than providing a detector on a cassette basis to share the single control circuit 46.

### Technical ideas

Technical ideas figured out from the embodiment described above, and effects and advantages of the technical ideas will be described below.
(A) A conveyance apparatus includes a conveyor configured to convey a medium; a first conveyance path along which the medium is conveyed by the conveyor; a second conveyance path along which the medium is conveyed by the conveyor; a first detector configured to detect multi-feed of the medium conveyed along the first conveyance path; a second detector configured to detect multi-feed of the medium conveyed along the second conveyance path; and a controller, wherein the controller includes a control circuit configured to selectively control the first detector and the second detector, and a switch coupled to the control circuit and configured to switch a control target of the control circuit between the first detector and the second detector. According to the configuration described above, the controller can control the first detector and the second detector via the common control circuit. A concern that the size of the entire apparatus increases is thus suppressed.
(B) In the conveyance apparatus described above, the controller may be configured to calibrate the first detector when the control target of the control circuit is switched by the switch to the first detector, and calibrate the second detector when the control target of the control circuit is switched by the switch to the second detector. According to the configuration described above, the multi-feed detection accuracy is improved by the calibration. Furthermore, downtime that occurs when only the first detector is used can be suppressed.
(C) In the conveyance apparatus described above, the controller may be configured to measure an output value from the first detector in a state in which no medium is located at the first detector when the control target of the control circuit is switched by the switch to the first detector, and calibrate the first detector based on a result of comparison between the output value and a threshold, and calibrate the second detector based on the result of the comparison when the first detector is calibrated and then the control target of the control circuit is switched by the switch to the second detector. To calibrate any of the detectors, the controller requires an output value from the detector in the state in which no medium is located. Therefore, when calibrating the first detector, the controller measures the output value from the first detector in the state in which no medium is located at the first detector. When the first detector is calibrated, and then the switch switches the control target of the control circuit to the second detector, calibrating the second detector as in the case of the first detector may lower the conveyance efficiency. According to the configuration described above, when the first detector is calibrated and then the control target of the control circuit is switched by the switch to the second detector, the controller calibrates the second detector based on the result of the comparison between the output value from the first detector and the threshold. That is, the controller calibrates the second detector without measuring the output value from the second detector in the state in which no medium is located at the second detector. In short, the controller uses the result of the comparison in the first detector for the calibration of the second detector. A concern that the conveyance efficiency decreases is thus reduced.
(D) In the conveyance apparatus described above, the controller may be configured to calibrate the first detector and the second detector when the medium is conveyed along the first conveyance path. According to the configuration described above, the first detector and the second detector are efficiently calibrated. In particular, when both the first detector and the second detector are used, a situation in which the conveyance is stopped halfway can be suppressed.
(E) In the conveyance apparatus described above, the controller may be configured to calibrate the second detector and then calibrate the first detector. When the first detector is calibrated, and then the second detector is calibrated, it is necessary to switch the control target of the control circuit by the switch to the first detector again in order to detect multi-feed of the medium conveyed along the first conveyance path. According to the configuration described above, since the second detector is calibrated and then the first detector is calibrated, the first detector can detect multi-feed of the medium conveyed along the first conveyance path without switching the control target of the control circuit by the switch after the calibration of the first detector is completed.
(F) In the conveyance apparatus described above, the controller may be configured not to calibrate the second detector when the first detector and the second detector are calibrated and then the control target of the control circuit is switched by the switch from the first detector to the second detector. According to the configuration described above, a concern that the second detector is repeatedly calibrated in a short period is reduced. A concern that the processing efficiency decreases is thus reduced.
(G) In the conveyance apparatus described above, the controller may be configured to measure an output value from the first detector in a state where no medium is located at the first detector whenever the medium is conveyed along the first conveyance path, and calibrate the first detector by changing a multi-feed threshold based on a result of comparison between the output value and a calibration threshold. According to the configuration described above, since the period required to change the multi-feed threshold is relatively short, the processing efficiency is unlikely to decrease even when the calibration is performed whenever the medium is conveyed. Performing the calibration whenever the medium is conveyed improves the multi-feed detection accuracy.
(H) The conveyance apparatus described above may further include a power supply circuit configured to supply power to the first detector and the second detector, the first detector may include a transmission sensor configured to transmit an ultrasonic wave having an intensity according to a voltage applied by the power supply circuit, and a reception sensor configured to output an output value according to an intensity of the ultrasonic wave received from the transmission sensor, and the controller may be configured to measure the output value in a state in which no medium is located at the first detector, and calibrate the first detector by increasing the applied voltage in a way that the output value falls within a range indicated by a threshold based on a result of comparison between the output value and the threshold. When the applied voltage increases, the output value increases. Depending on the configuration of the power supply circuit, the period required to decrease the applied voltage may be longer than the period required to increase the applied voltage. Therefore, according to the configuration described above, when the output value in the state in which no medium is located at the first detector is smaller than the threshold, the controller increases the applied voltage to efficiently adjust the output value.
(I) A processing apparatus includes the conveyance apparatus described above; and a processing unit configured to perform processing on the medium conveyed along the first conveyance path and the second conveyance path. The configuration described above provides the same advantages as the conveyance apparatus described above.
(J) In the processing apparatus described above, the processing unit may be a recorder configured to record an image on the medium. According to the configuration described above, the processing apparatus including the recorder provides the same advantages as the conveyance apparatus described above.
(K) The processing apparatus described above may further include a cassette on which the medium is stacked; and a tray on which the medium is stacked, one of the first conveyance path and the second conveyance path may extend from the cassette toward the processing unit, and another of the first conveyance path and the second conveyance path may extend from the tray toward the processing unit. According to the configuration described above, the processing apparatus in which the medium is conveyed from each of the cassette and the tray to the processing unit provides the same advantages as the conveyance apparatus described above. In general, supplying the medium from the cassette and supplying the medium from the tray are not often continuously switched from one to the other, so that an advantage provided by sharing the single control circuit is readily provided.
(L) In the processing apparatus described above, the cassette may be a first cassette, the processing apparatus may further include a second cassette on which the medium is stacked, the second cassette may be located below the first cassette, and the medium may be conveyed from each of the first cassette and the second cassette to the processing unit along the one of the first conveyance path and the second conveyance path. According to the configuration described above, multi-feed of the medium conveyed from the first cassette and multi-feed of the medium conveyed from the second cassette are detected by a common detector. The number of the detectors is therefore reduced as compared with a configuration in which a detector is provided on a cassette basis. In general, the frequency of continuous switching between supplying the medium from the first cassette and supplying the medium from the second cassette is higher than the frequency of continuous switching between supplying the medium from any of the cassettes and supplying the medium from the tray. The detectors are therefore more efficiently calibrated than providing a detector on a cassette basis to share the single control circuit.

What is claimed is:

1. A conveyance apparatus comprising:
a conveyor configured to convey a medium;
a first conveyance path along which the medium is conveyed by the conveyor;
a second conveyance path along which the medium is conveyed by the conveyor;
a first detector configured to detect multi-feed of the medium conveyed along the first conveyance path;
a second detector configured to detect multi-feed of the medium conveyed along the second conveyance path; and
a controller,
wherein the controller includes
a control circuit configured to control a selected one of the first detector and the second detector, and
a switch coupled to the control circuit and configured to switch a control target of the control circuit between the first detector and the second detector.

2. The conveyance apparatus according to claim 1, wherein
the controller is configured to
calibrate the first detector when the control target of the control circuit is switched by the switch to the first detector, and
calibrate the second detector when the control target of the control circuit is switched by the switch to the second detector.

3. The conveyance apparatus according to claim 1, wherein
the controller is configured to
measure an output value from the first detector in a state in which no medium is located at the first detector when the control target of the control circuit is switched by the switch to the first detector, and calibrate the first detector based on a result of comparison between the output value and a threshold, and
calibrate the second detector based on the result of the comparison when the first detector is calibrated and then the control target of the control circuit is switched by the switch to the second detector.

4. The conveyance apparatus according to claim 1, wherein the controller is configured to calibrate the first detector and the second detector when the medium is conveyed along the first conveyance path.

5. The conveyance apparatus according to claim 4, wherein the controller is configured to calibrate the second detector and then calibrate the first detector.

6. The conveyance apparatus according to claim 4, wherein the controller is configured not to calibrate the second detector when the first detector and the second detector are calibrated and then the control target of the control circuit is switched by the switch from the first detector to the second detector.

7. The conveyance apparatus according to claim 1, wherein the controller is configured to measure an output value from the first detector in a state where no medium is located at the first detector whenever the medium is conveyed along the first conveyance path, and calibrate the first detector by changing a multi-feed threshold based on a result of comparison between the output value and a calibration threshold.

8. The conveyance apparatus according to claim 1, further comprising
a power supply circuit configured to supply power to the first detector and the second detector,
wherein the first detector includes
a transmission sensor configured to transmit an ultrasonic wave having an intensity according to a voltage applied by the power supply circuit, and
a reception sensor configured to output an output value according to an intensity of the ultrasonic wave received from the transmission sensor, and
the controller is configured to measure the output value in a state in which no medium is located at the first detector, and calibrate the first detector by increasing the applied voltage in a way that the output value falls within a range indicated by a threshold based on a result of comparison between the output value and the threshold.

9. A processing apparatus comprising:
the conveyance apparatus according to claim 1; and
a processing unit configured to perform processing on the medium conveyed along the first conveyance path and the second conveyance path.

10. The processing apparatus according to claim 9, wherein the processing unit is a recorder configured to record an image on the medium.

11. The processing apparatus according to claim 9, further comprising:
a cassette on which the medium is stacked; and
a tray on which the medium is stacked,
wherein one of the first conveyance path and the second conveyance path extends from the cassette toward the processing unit, and
another of the first conveyance path and the second conveyance path extends from the tray toward the processing unit.

12. The processing apparatus according to claim 11, wherein
the cassette is a first cassette,
the processing apparatus further comprises a second cassette on which the medium is stacked,
the second cassette is located below the first cassette, and
the medium is conveyed from each of the first cassette and the second cassette to the processing unit along the one of the first conveyance path and the second conveyance path.
